(19) United States
(12) Patent Application Publication
(10) Pub. No.: US 2026/0143352 A1
(43) Pub. Date: May 21, 2026

(54) RECONFIGURABLE INTELLIGENT SURFACE CONTROLLING DEVICE AND METHOD

(71) Applicant: INDUSTRIAL TECHNOLOGY RESEARCH INSTITUTE, HSINCHU (TW)

(72) Inventors: Pin-Siang HUANG, Taipei City (TW); Wei-Cheng WANG, Taichung City (TW); Bo-Wei CHEN, Changhua County (TW)

(21) Appl. No.: 18/955,895

(22) Filed: Nov. 21, 2024

(51) Int. Cl. H04W 16/18; H04W 16/22; H04W 36/32

(52) U.S. Cl. CPC H04W 16/18; H04W 16/22; H04W 36/322

(57) ABSTRACT

A device for wireless communication is provided. The device comprises a processor configured to: send a request to an first base station for connection status of a user device; send a sensing command to the first base station to scan an area in a coverage of the first base station to generate environment feature data; perform a neural network inference according to the environment feature data to generate a predicted position of the user device; and control a first reconfiguration intelligent surface (RIS) device according to the predicted position.

### BACKGROUND

### Field of Invention

The present disclosure relates to reconfigurable intelligent surface controlling device and method. More particularly, the present disclosure relates to reconfigurable intelligent surface controlling device and method through integrated sensing and communication.

### Description of Related Art

A Reconfigurable intelligent surface (RIS), also referred to as intelligent reflecting surface (IRS), is a surface structure composed of multiple reflecting units. The RIS is used to manipulate electromagnetic signals. Specifically, through adjusting configurations of the reflecting units, the reflecting angle of the RIS could be controlled. Strategically changing the angles of multiple RISs between a transmitter and a receiver, the quality and coverage of the electromagnetic signals can be significantly enhanced.

### SUMMARY

In some embodiments, a device for wireless communication is provided. The device comprises a processor configured to: send a request to a first base station for connection status of a user device; send a sensing command to the first base station to scan an area in a coverage of the first base station to generate environment feature data; perform a neural network inference according to the environment feature data to generate a predicted position of the user device; and control a first reconfiguration intelligent surface (RIS) device according to the predicted position.

In some embodiments, a method for wireless communication is provided. The method comprises: sending a request to a first base station for connection status of a user device; sending a sensing command to the first base station to scan an area in a coverage of the first base station to generate environment feature data; performing a neural network inference according to the environment feature data to generate a predicted position of the user device; and controlling a first RIS device according to the predicted position.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a system for wireless communication in accordance with various embodiments of the present disclosure.

FIG. 2 is a schematic diagram of an example of the system in FIG. 1 in accordance with various embodiments of the present disclosure

FIG. 3 is a flowchart diagram of a method for operating a sense module, a prediction module, a path module, a decision module, a RIS control module and a handover module, the controller and the system as shown in FIGS. 1-2, in accordance with various embodiments of the present disclosure.

FIG. 4 is schematic diagram of an example of the machine learning model of the prediction module, in accordance with various embodiments of the present disclosure.

FIG. 5 depicts an example of the controller determining the optimized path, in accordance with various embodiments of the present disclosure.

FIG. 6 depicts an example of the controller determining the handover type, in accordance with various embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. Well-known implementations or operations are not shown or described in detail to avoid obscuring aspects of various embodiments of the present disclosure.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

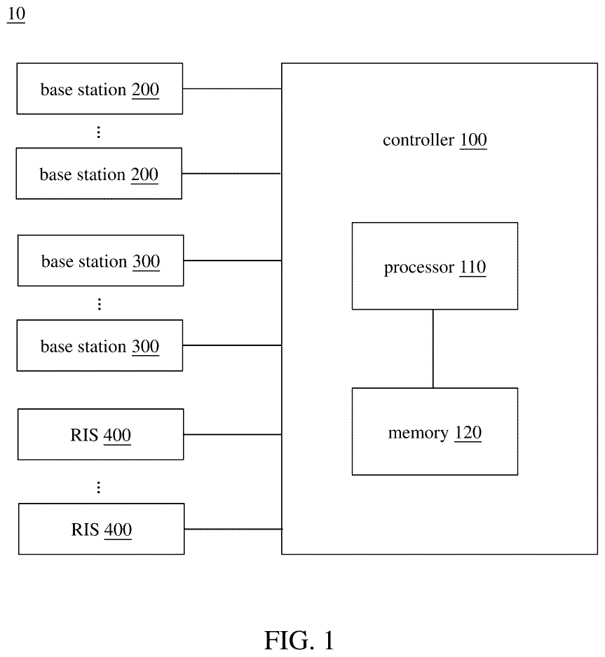

Reference is now made to FIG. 1. FIG. 1 is a schematic diagram of a system 10 for wireless communication in accordance with various embodiments of the present disclosure. In some embodiments, the system 10 is a mobile telecommunication system. In some embodiments, the system 10 is a radio access network (RAN) system.

As shown in FIG. 1, the system 10 includes a controller 100, one or more base stations 200, one or more base stations 300 and one or more RISs 400. The controller 100 is coupled to the base stations 200, 300 and the RISs 400 through electrical connection or wireless communication.

The base stations 200 and 300 are configured to communicate with one or more user devices (user equipment) such as smartphones, tablets, etc. For example, the base stations 200 and 300 transmit radio signals to the user devices and receive radio signals from the user devices.

In some embodiments, the base stations 200 are configured to transmit signals in a first frequency range that has a first coverage (i.e., the maximum area for communication) and the base stations 300 are configured to transmit signals in a second frequency range that has a second coverage smaller than the first coverage.

In some embodiments, the first frequency range is the frequency range 1 (FR1), for example, frequency range from 410 MHz to 7125 MHz. The second frequency range is the frequency range 2 (FR2) higher than the FR1, for example, frequency range from 24.25 GHz to 52.6 GHz.

The RISs 400 are configured to propagate signals between base stations 300 and the user devices. For example, multiple RISs form a signal propagation path to transmit a radio signal from a base station 300 to a user device.

The controller 100 is configured to control the base stations 200, 300 and the RISs 400. For example, the controller 100 selects one base station 200 to transmit radio signals to a user device and determines the reflecting angles of the RISs 400 to propagate the radio signals.

In some embodiments, the controller 100 includes a processor 110 and a memory 120. The processor 110 is electrically connected to the memory 120. In some embodiments, the processor 110 and the memory 120 cooperate to determine the configurations of the base stations 200, 300 and the RISs 400. For example, the processor 110 determines the reflecting angles of the RISs 400 according to data in the memory 120.

According to various embodiments, the processor 110 may comprise a central processing unit (CPU), or other programmable general-purpose or special-purpose micro control units (MCU), microprocessors, digital signal processors (DSP), programmable controllers, application-specific integrated circuits (ASIC), graphics processing units (GPU), arithmetic logic units (ALU), complex programmable logic devices (CPLD), field-programmable gate arrays (FPGA), or other similar components or a combination of the above components.

According to various embodiments, the memory 120 may be a hard disk, a random-access memory, other storage media or a combination thereof.

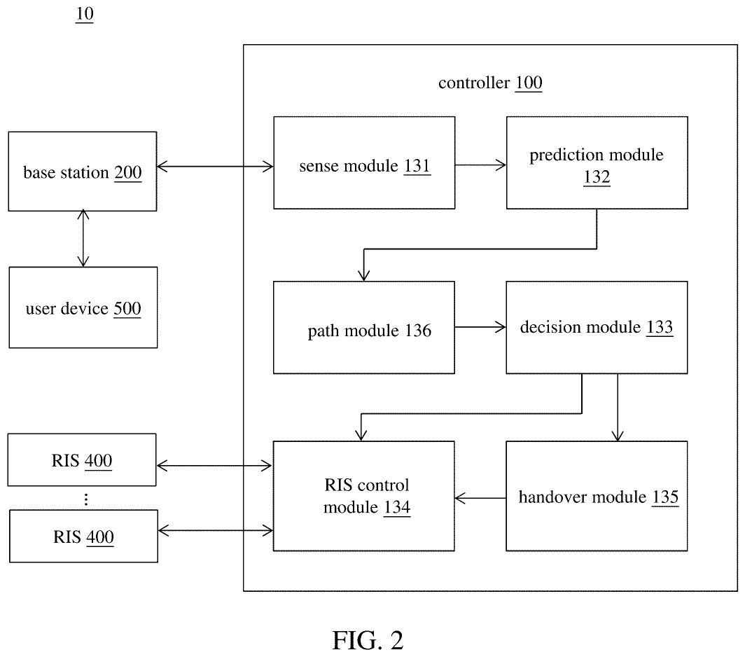

Reference is now made to FIG. 2. FIG. 2 is a schematic diagram of an example of the system 10 in FIG. 1 in accordance with various embodiments of the present disclosure.

As shown in FIG. 2, the controller 100 includes a sense module 131, a prediction module 132, a path module 136, a decision module 133, a RIS control module 134 and a handover module 135.

In some embodiments, the sense module 131, the prediction module 132, the path module 136, the decision module 133, the RIS control module 134 and the handover module 135 are implemented by the processor 110.

A person having ordinary skill in the art would further appreciate that any of the various modules described in connection with the aspects disclosed herein could be implemented as electronic hardware (e.g., the processor 110), various forms of program or design code incorporating instructions, or combinations of both. To clearly illustrate this interchangeability of hardware and software, various illustrative modules have been described below generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

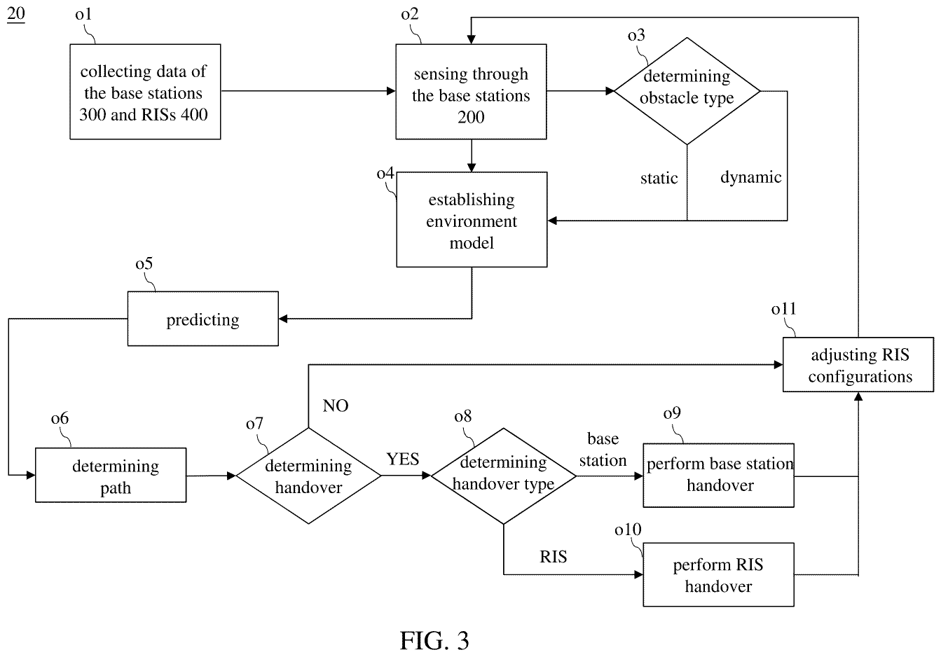

Reference is now made to both FIGS. 2 and 3. FIG. 3 is a flowchart diagram of a method 20 for operating the sense module 131, the prediction module 132, the path module 136, the decision module 133, the RIS control module 134 and the handover module 135, the controller 100 and the system 10 as shown in FIGS. 1-2, in accordance with various embodiments of the present disclosure. It is understood that additional operations could be provided before, during, and after the operations shown by FIG. 3, and some of the operations described below could be replaced or eliminated, for additional embodiments of the method. The order of the operations may be interchangeable. Throughout the various views and illustrative embodiments, like reference numbers are used to designate like elements. The method 20 includes operations o1-o11 that are described below with reference to the system 10 as shown in FIGS. 1-2. In some embodiments, the method 20 is implemented as program codes stored in a non-transitory computer-readable medium (e.g., the memory 120).

In the operation o1, the sense module 131 is configured to collect data of the base stations 300 and the RISs 400. For example, the sense module 131 receives the positions of the base stations 300 from the base stations 300. The sense module 131 also receives the position and the adjustable range of the reflecting angle of each RIS 400 from the RIS 400.

In some embodiments, a user device 500 is connected to a first base station 200. For simplicity, only the first base station 200 are depicted in FIG. 2 with other base stations 200, 300 omitted.

The sense module 131 is further configured to periodically send a status check command to the first base station 200 to check a connection status between the first base station 200 and the user device 500.

The first base station 200 transmits a connection status request to the user device 500. The user device 500 sends a connection status feedback to the first base station 200 in response to the connection status request. Then, the first base station 200 further sends the connection status feedback to the sense module 131.

When the sense module 131 receives the connection status feedback, the sense module 131 determines that the user device 500 is connected to the first base station 200. On the contrary, when the sense module 131 does not receive the connection status feedback, the sense module 131 determines that the user device 500 is disconnected from the first base station 200.

When the sense module 131 determines that the user device 500 is disconnected from the first base station 200, the sense module 131 sends a command to the first base station 200 or multiple base stations 200 to sense the environment for the first base station 200 or any other station 200 to connect the user device 500. For example, the sense module 131 sends a command to the first base station 200 and the first base station 200 senses the environment (area within the coverage of the first base station 200) to search the user device 500. When the user device 500 in the coverage is sensed by the first base station 200, the first base station 200 connects the user device 500.

In some embodiments, the sense module 131 repeatedly sends the command to the first base station 200 or the multiple base stations 200 until it receives the connection status feedback from the first base station 200 or any other base station 200.

In some embodiments, when the user device 500 is connected to the first base station 200, the operation o2 is performed.

In operation o2, the sense module 131 generates sensing commands to the base stations 200 and 300. The base stations 200 and 300 sense the environment in response to the sensing command to generate environment feature data. For example, the base stations 200 and 300 utilize integrated sensing and communication (ISAC) technology to sense the environment in response to the sensing command.

Specifically, the ISAC technology is to integrate sensing into communication. For example, each of the base stations 200 and 300 uses its radio signals to sense (scan) the environment. For example, each of the base stations 200 and 300 uses its radio signals to sense the features like position, orientation, size, velocity, etc. of objects in its coverage to generate the environment feature data. In some embodiments, the environment feature data includes ISAC data (e.g., point cloud) captured through scanning the environment with the radio signals.

In operation o3, the sense module 131 determines the type of the object (obstacle) sensed in the environment. For example, the sense module 131 determines whether the obstacle is static or dynamic (e.g., a moving car).

In some embodiments, the memory 120 stores the environment feature data (e.g., ISAC data) corresponding to different times and the sense module 131 determines the type of the obstacle by comparing the environment feature data corresponding to different times. For example, when the position of an obstacle differs in different times according to the environment feature data corresponding to the different times, the sense module 131 determines the type of the obstacle as dynamic.

In some embodiments, the base stations 200 and 300 generate channel state information (CSI) through ISAC. In some embodiments, the sense module 131 is further configured to request CSI from the base stations 200 and/or 300. For example, the sense module 131 requests the CSI of the channel between the device 500 and the base station 200 or 300. Through the CSI, the sense module 131 could determine information (e.g., phase, amplitude and delay) of signal between the device 500 and the base station 200 or 300.

In some embodiments, the sense module 131 receives the position data of the device 500 from the first base station 200 or 300. In some embodiments, the memory 120 stores the position data of the device 500. In some embodiments, the memory 120 stores the historical position data of the device 500 corresponding to different times.

In the operation o4, the sense module 131 establishes an environment model (i.e., a set of data) according to the environment feature data, the CSI and the historical position data. In some embodiments, the sense module 131 concatenates the environment feature data, the CSI and the historical position data to generate the environment model.

In the operation o5, the prediction module 132 performs a prediction according to the environment model to generate a predicted position of the user device 500.

In some embodiments, the prediction module 132 performs an inference of a machine learning model (e.g., neural network) to generate the predicted position of the user device 500.

In some embodiments, the machine learning model receives the environment model as its input and generates the predicted position of the user device 500 as its output.

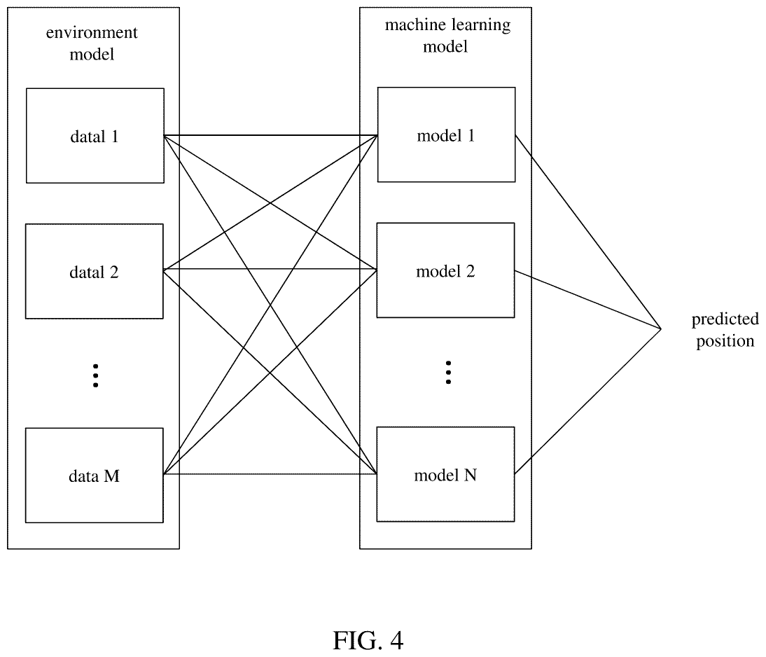

Reference is now made to FIGS. 1-4. FIG. 4 is schematic diagram of an example of the machine learning model of the prediction module 132, in accordance with various embodiments of the present disclosure.

As shown in FIG. 4, the environment model may include data1 to data M (e.g., the environment feature data, the CSI and the historical position data). The machine learning model may include a model 1 to a model N. M and N are natural numbers. For example, the machine learning model may include a convolution neural network (CNN), a recurrent neural network (RNN), a graph convolutional network (GCN), and so on.

In some embodiments, the machine learning model is an ensemble model combining model 1 to model N. For example, the model 1 receives the data 1 to data M as input and generates a first output, the model 2 receives the data 1 to data M as input and generate a second output ... and the model N receives the data 1 to data M as input and generate a N-th output. The machine learning model performs an ensemble voting operation according to the first to N-th output to generate the predicted position.

In the operation o6, the path module 136 determines an optimized path for the signals propagated between the first base station 300 to the user device 500. In some embodiments, the path module 136 determines the optimized path according to the predicted position, the positions of the base stations 300, the positions of the RISs 400, the reflecting angle ranges of the RISs 400 and the environment feature data.

For example, the path module 136 determines the RISs 400 to form a path to propagate signals between the first base station 300 and the user device 500. The path module 136 may generate different paths of the RISs to propagate the signals between the first base station 300 and the user device 500.

In some embodiments, the path module 136 selects the shortest one of the paths as the optimized path. In various embodiments, the path module 136 selects, among the paths, the path formed by the fewest RISs 400 as the optimized path.

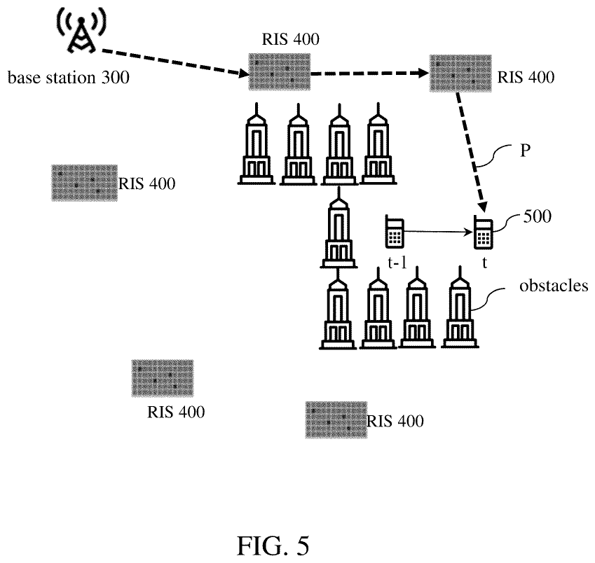

Reference is now made to FIGS. 1-5. FIG. 5 depicts an example of the controller 100 determining the optimized path, in accordance with various embodiments of the present disclosure. As shown in FIG. 4, the prediction module 132 generates the predicted position of the user device 500 corresponding to a time t according to the environment model at the time t−1 earlier than the time t.

Then the path module 136 determines an optimized path P that is shortest or using the fewest RISs 400 to connect the base station 300 and the user device 500.

In some embodiments, after the optimized path is determined, the operation o7 is performed to determine whether to perform a handover.

In the operation o7, the decision module 133 generates a result indicating whether a handover is needed according to the optimized path.

In some embodiments, the memory 120 stores the previous optimized path generated by the path module 136. In other words, the memory 120 records the base station 300, the RISs 400 used to connect to the user device 500.

In some embodiments, the decision module 133 compares a current optimized path with the previous optimized path to determine whether a RIS 400 used in the previous optimized path is replaced by another RIS 400 to form the current optimized path.

Similarly, the decision module 133 compares the current optimized path with the previous optimized path to determine whether a base station 300 used in the previous optimized path is replaced by another base station 300 to form the current optimized path.

When the decision module 133 determines that a RIS 400 or base station 300 used in the previous path is replaced to form the current optimized path, the decision module 133 determines that a handover is needed.

On the contrary, when the decision module 133 determines that no RIS 400 and no base station 300 used in the previous path is replaced to form the current optimized path, the decision module 133 determines that a handover is not needed.

In the operation o8, the decision module 133 determines a handover type. The decision module 133 determines the handover type as a base station handover type when the decision module 133 determines that a base station 300 used in the previous optimized path is replaced by another base station 300 to form the current optimized path.

On the contrary, the decision module 133 determines the handover type as a RIS handover type when the decision module 133 determines that only RIS 400 is replaced to form the current optimized path.

In the operation o9, when the handover type is the base station handover type, the handover module 135 generates hand over command to a first base station 300 and a second base station 300, in which the second base station 300 replaces the first base station 300 to form the current optimized path. Then, the first and second base stations 300 perform a handover operation in response to the handover command.

In the operation o10, when the handover type is the RIS handover type, the handover module 135 generates hand over command to a first RIS 400 and a second RIS 400 to perform a handover thereof, in which the second RIS 400 replaces the first RIS 400 to form the current optimized path. Then, the first and second RISs 400 perform a handover operation in response to the handover command.

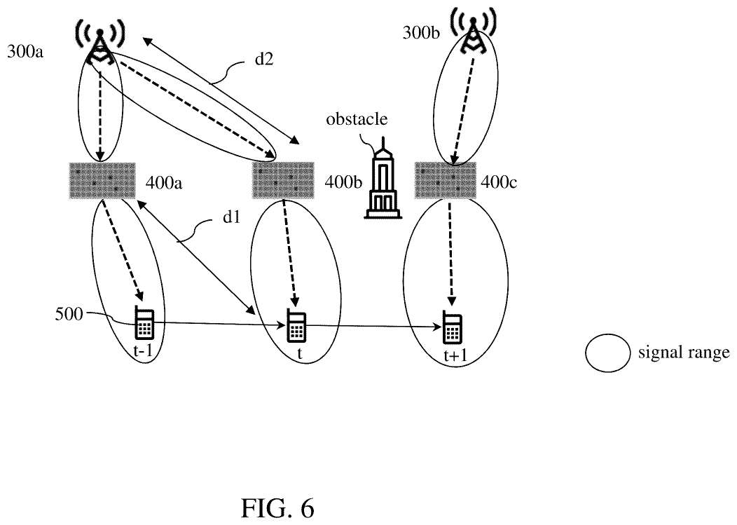

Reference is now made to FIGS. 1-6. FIG. 6 depicts an example of the controller 100 determining the handover type, in accordance with various embodiments of the present disclosure.

As shown in FIG. 6, at a time t−1, the optimized path to the user device 500 is formed by a base station 300a (a first base station 300) and a RIS 400a (a first RIS 400).

Then, the prediction module 133 generates a predicted position of the user device 500 corresponding to a time t after the time t−1. When the path module 136 determines that a distance between the RIS 400a and the predicted position of the user device 500 corresponding to a time t is greater than a maximum signal range d1 of the RIS 400a (i.e., the user device 500 being outside of the coverage of the RIS 400a), the path module 136 replaces the RIS 400a with a RIS 400b (a second RIS 400) to form the optimized path corresponding to the time t. The predicted position of the user device 500 corresponding to the time t is in the coverage of the RIS 400b.

The decision module 133 determines that the handover type corresponding to the time t as the RIS handover type. The handover module 135 generates the command for the RISs 400a and 400b to perform the RIS handover operation.

Then, the prediction module 133 generates a predicted position of the user device 500 corresponding to a time t+1 after the time t. As shown in FIG. 6, when the path module 136 determines that the user device 500 at the predicted position corresponding to a time t+1 are blocked from the RIS 400b by the obstacle, the path module 136 replaces the RIS 400b with a RIS 400c (a third RIS 400) to form the optimized path corresponding to the time t+1.

When the path module 136 determines that a distance between the RIS 400c and the base station 300a is greater than a maximum signal range d2 of the base station 300a (i.e., the RIS 400c being outside of the coverage of the base station 300a), the path module 136 replaces the base station 300a with a base station 300b (a second base station 300) to form the optimized path corresponding to the time t+1. The RIS 400c is in the coverage of the base station 300b.

The decision module 133 determines that the handover type corresponding to the time t+1 as the base station handover type. The handover module 135 generates the command for the base station 300a and 300b to perform the base station handover operation.

In some embodiments, after the handover operation is performed, the operation o11 is performed to adjust RIS angles. In some embodiments, when the decision module 133 determines that a handover is not needed, the operation o11 is performed to adjust RIS angles.

In the operation o11, the decision module 133 determines the configurations of the RISs 400 in the optimized path according to the environment feature data and the optimized path (positions of base station 300, RISs 400 in the optimized path and the predicted position). For example, the decision module 133 determines the reflecting angles of the RISs 400 in the optimized path to propagate radio signals between the optimized path. For example, the reflecting angle of a RIS 400 in the optimized path is adjusted to reflect radio signal from a source RIS 400 to a destination RIS 400 in the optimized path.

In some embodiments, the RIS control module 134 is a service management and orchestration (SMO) module to control the RISs 400. The RIS control module 134 controls the RISs 400 in the optimized path according to the configurations determined by the decision module 133. For example, the RIS control module 134 generates angle adjusting command to the RISs according to the configurations determined by the decision module 133, and the RISs change their reflecting angles in response to the angle adjusting command.

In some embodiments, after the operation o11 is performed, the operations o2 is performed again to sense the environment for generating the next predicted position of the device 500 and controlling the base stations 300 and RISs 400.

The configurations of FIGS. 1-6 are given for illustrative purposes. Various implements are within the contemplated scope of the present disclosure. For example, in some embodiments, a base station 200 and a base station 300 could be integrated as a single base station.

In view of the above, a system, a device and a method for wireless communication are provided. The provided system, device and method utilize the ISAC technology to sense the environment and predict a user device position according to the sensed environment data. The provided system, device and method further adjust the configurations of RISs to establish a signal propagation path to the user device according to the prediction and the environment data. The provided system, device and method help improve wireless communication performance.

While the disclosure has been described by way of example(s) and in terms of the preferred embodiment(s), it is to be understood that the disclosure is not limited thereto. Those skilled in the art may make various changes, substitutions, and alterations herein without departing from the spirit and scope of the present disclosure. In view of the foregoing, it is intended that the present disclosure cover modifications and variations of this invention provided they fall within the scope of the following claims.

What is claimed is:

1. A device for wireless communication, comprising:
a processor configured to:
send a request to an first base station for connection status of a user device;
send a sensing command to the first base station to scan an area in a coverage of the first base station to generate environment feature data;
perform a neural network inference according to the environment feature data to generate a predicted position of the user device; and
control a first reconfiguration intelligent surface (RIS) device according to the predicted position.

2. The device of claim 1, wherein the processor is further configured to determine a plurality of signal paths between a second base station and the user device, and determine a shortest one of the plurality of signal paths as an optimized path, and
the processor is further configured to adjust the configurations of a plurality of RIS devices in the optimized path to propagate signals between the second base station and the user device.

3. The device of claim 2, wherein the first base station is configured to generate radio signals in a first frequency range and the second base station is configured to generate radio signals in a second frequency range higher than the first frequency range.

4. The device of claim 1, wherein the device is further configured to request location data from a first plurality of RIS devices that comprise the first RIS device,
wherein the processor is further configured to determine a second plurality of RIS devices among the first plurality of RIS devices to form a signal path, according to the location data, the environment feature data and the predicted position.

5. The device of claim 4, wherein the processor is further configured to determine a plurality of signal paths between a second base station and the user device according to the location data, the environment feature data and the predicted position, and
the processor is further configured to determine a first path formed by the fewest RIS devices among the plurality of signal paths as an optimized path.

6. The device of claim 5, wherein the processor is further configured to determine reflecting angles of a third plurality of RIS devices in the optimized path to propagate signals between the second base station and the user device according to positions of the third plurality of RIS devices.

7. The device of claim 1, wherein the processor is further configured to determine a second RIS device to perform a hand over operation with the first RIS device according to the environment feature data and the predicted position.

8. The device of claim 1, wherein the user device is connected to a second base station at a first time,
wherein when the processor determines that the first RIS device to form a signal path to the user device is beyond a coverage of the second base station according to the predicted position corresponding to a second time after the first time, the processor is further configured to determine a third base station to perform a hand over operation with the second base station according to the environment feature data and the predicted position.

9. The device of claim 1, wherein the processor is further configured to send the sensing command to the first base station, and the first base station generates a point cloud as the environment feature data by scanning the area through radio signals.

10. The device of claim 1, further comprising:
a storage device configured to store historical environment feature data, wherein the processor is further configured to compare the historical environment feature data and the environment feature data to determine whether an object in the area is dynamic.

11. A method for wireless communication, comprising:
sending a request to an first base station for connection status of a user device;
sending a sensing command to the first base station to scan an area in a coverage of the first base station to generate environment feature data;
performing a neural network inference according to the environment feature data to generate a predicted position of the user device; and
controlling a first RIS device according to the predicted position.

12. The method of claim 11, further comprising:
repeating sending the sensing command to the first base station until the base station sends the connection status indicating a connection between the user device.

13. The method of claim 11, further comprising:
determining, according to the environment feature data and the predicted position, a signal path between a second base station and the user device; and
adjusting a reflecting angle of a second RIS device in the signal path to propagate a radio signal between the second base station and the user device.

14. The method of claim 13, further comprising:
generating, by the first base station, first signals in a first frequency range and generating, by the second base station, second signals in a second frequency range,
wherein the first frequency is lower than the second frequency range, and the coverage of the first signals are greater than the coverage of the second signals.

15. The method of claim 11, further comprising:
determining a second base station to connect to the user device according to positions of a plurality of second base stations, positions of a plurality of RIS devices, the environment feature data and the predicted position.

16. The method of claim 15, further comprising:
determining signal paths between the second base station and the user device according to the positions of the plurality of RIS devices, the environment feature data and the predicted position;
determining an optimized signal path that has the fewest RIS devices among the signal paths; and
adjusting reflecting angles of the RIS devices in the optimized signal path to connect the second base station and the user device.

17. The method of claim 11, further comprising:
sensing, through the first base station, channel state information (CSI) between the first base station and the user device; and
performing the neural network inference according to the environment feature data and the CSI to generate the predicted position of the user device.

18. The method of claim 11, further comprising:
storing historical environment feature data through a memory;
comparing the historical environment feature data and the environment feature data to determine dynamic obstacles; and
performing the neural network inference according to the environment feature data and the determination of the dynamic obstacles to generate the predicted position of the user device.

19. The method of claim 11, further comprising:
performing a plurality of neural network inferences according to the environment feature data to generate a predicted position of the user device; and
performing an ensemble voting operation according to results of the plurality of neural network inferences to generate the predicted position of the user device.

20. The method of claim 19, wherein the plurality of neural network inferences comprise a convolutional neural network inference, a recurrent neural network inference and a graph convolutional network inference.
